(19) United States
(12) Patent Application Publication
(10) Pub. No.: US 2003/0097489 A1
(43) Pub. Date: May 22, 2003

(54) Fast socket technology implementation using semaphores and memory maps

(76) Inventors: Nagendra Nagarajayya, Sunnyvale, CA (US); Sathyamangalam Ramaswamy Venkatramanan, Cupertino, CA (US); Ezhilan Narasimhan, Cupertino, CA (US)

Correspondence Address: David B. Ritchie, Thelen Reid & Priest LLP, P.O. Box 640640, San Jose, CA, 95164-0640, US

(21) Appl. No.: 09/991,596

(22) Filed: Nov. 21, 2001

(51) Int. Cl. G06F 9/00; G06F 9/46

(52) U.S. Cl. 709/328

(57) ABSTRACT

A method and apparatus moves data between processes in a computer-based system. Each process calls for one or more symbols in a first library. A second library comprises one or more equivalent symbols with Fast Sockets technology having a door interprocess communication mechanism. The call for a symbol in the first library from each process is interposed with a corresponding symbol in the second library. Each process communicates synchronization signals using semaphores. Each process transfers data through a mapped memory based on the synchronization signals.

### CROSS REFERENCES

The present application is related to co-pending application entitled “Fast Socket Technology Implementation using Doors” by inventors Nagendra Nagarajayya, Sathyamangalam Ramaswamy Venkatramanan, Ezhilan Narasimhan (attorney docket number SUN-P6303). The present application is also related to co-pending application entitled “Fast Socket Technology Implementation using Doors and Memory Maps” by inventors Nagendra Nagarajayya, Sathyamangalam Ramaswamy Venkatramanan, Ezhilan Narasimhan (attorney docket number SUN-P6304) all commonly assigned herewith.

### FIELD OF THE INVENTION

The present invention relates to interprocess communication. More particularly, the present invention relates to interprocess communication utilizing an interposition technique.

### BACKGROUND OF THE INVENTION

Interprocess communication (IPC) is the exchange of data between two or more processes. Various forms of IPC exists: pipes, sockets, shared memory, message queues, and Solaris™ doors.

A pipe provides the ability for a byte of data to flow in one direction and is used between processes. These two processes must be of common ancestry. Typically, a pipe is used to communicate between two processes such that the output of one process becomes the input of another process. FIG. 1 illustrates a conventional pipe 100 according to a prior art. The output of process 102 becomes the input of process 104. Pipe 100 is terminated when process 102 that is referencing it terminates. Data is moved from process 102 to process 104 through a pipe 100 situated within a kernel 106.

A socket is another form of IPC. It is a network of communications endpoints. FIG. 2 illustrates sockets 200 and 202 according to a prior art. A process 204 communicates with another process 206 through a couple of sockets 200 and 202 via a kernel 208. The advantages of sockets include high data reliability, high data throughput, and variable message sizes. However these features require a high setup and maintenance overhead, making the socket technique undesirable for interprocess communications on the same machine. The data availability signal 210 is transmitted through the kernel 208. Applications using sockets transfer data call a read function 212 and a write function 214. These calls make use of the kernel 208 to move data by transferring it from the user space to the kernel 208, and from the kernel 208 back to the user space, thus incurring system time. Though this kernel dependency is necessary for applications communicating across a network, it impacts system performance when used for communication on the same machine.

Shared memory is another form of IPC. FIG. 3 illustrates the use of a shared memory 300 to communicate process 302 with process 304. Shared memory is an IPC technique that provides a shared data space that is accessed by multiple computer processes and may be used in combination with semaphores. Shared memory allows multiple processes to share virtual memory space. Shared memory provides a quick but sometimes complex method for processes to communicate with one another. In general, process 302 creates/allocates the shared memory segment 300. The size and access permissions for the segment 300 are set when the segment 300 is created. The process 304 then attaches the shared memory segment 300, causing the shared segment 300 to be mapped into the current data space of the process 304. (The actual mapping of the segment to virtual address space is dependent upon the memory management hardware for the system.) If necessary, the process 302 then initializes the shared memory 300. Once created, other processes, such as process 304, can gain access to the shared memory segment 300. Each process maps the shared memory segment 300 into its data space. Each process accesses the shared memory 300 relative to an attachment address. While the data that these processes are referencing is in common, each process will use different attachment address values. Locks are often used to coordinate access to shared memory segment 300. When process 304 is finished with the shared memory segment 300, process 304 can then detach from the shared memory segment 300. The creator of the memory segment 300 may grant ownership of the memory segment 300 to another process. When all processes are finished with the shared memory segment 300, the process that created the segment is usually responsible for removing the shared memory segment 300. Using shared memory, the usage of kernel 306 is minimized thereby freeing the system for other tasks.

The fastest form of IPC on Solaris™ Operating System from Sun Microsystems Inc. is doors. However, applications that want to communicate using doors need to be explicitly programmed to do so. Even though doors IPC is very fast, the socket-based IPC is more popular since it is portable, flexible, and can be used to communicate across a network.

A definite need exists for a fast IPC technology that would overcome the drawbacks of doors and socket-based IPC. Specifically, a need exists for a fast socket technology implementation using memory maps and semaphores. A primary purpose of the present invention is to solve these needs and provide further, related advantages.

### BRIEF DESCRIPTION OF THE INVENTION

A method and apparatus moves data between processes in a computer-based system. Each process calls for one or more symbols in a first library. A second library comprises one or more equivalent symbols with Fast Sockets technology having a door interprocess communication mechanism. The call for a symbol in the first library from each process is interposed with a corresponding symbol in the second library. Each process communicates synchronization signals using semaphores. Each process transfers data through a mapped memory based on the synchronization signals.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram illustrating an interprocess communication using pipes according to a prior art;

FIG. 2 is a block diagram illustrating an interprocess communication using sockets according to a prior art;

FIG. 3 is a block diagram illustrating an interprocess communication using a shared memory according to a prior art;

FIG. 4 is a block diagram illustrating an interprocess communication using the Speed Library according to a specific embodiment of the present invention;

FIG. 5 is a flow diagram illustrating a method for moving data between processes according to a specific embodiment of the present invention; and

FIG. 6 is a block diagram illustrating a memory describing an interprocess communication using the Speed Library according to a specific embodiment of the present invention.

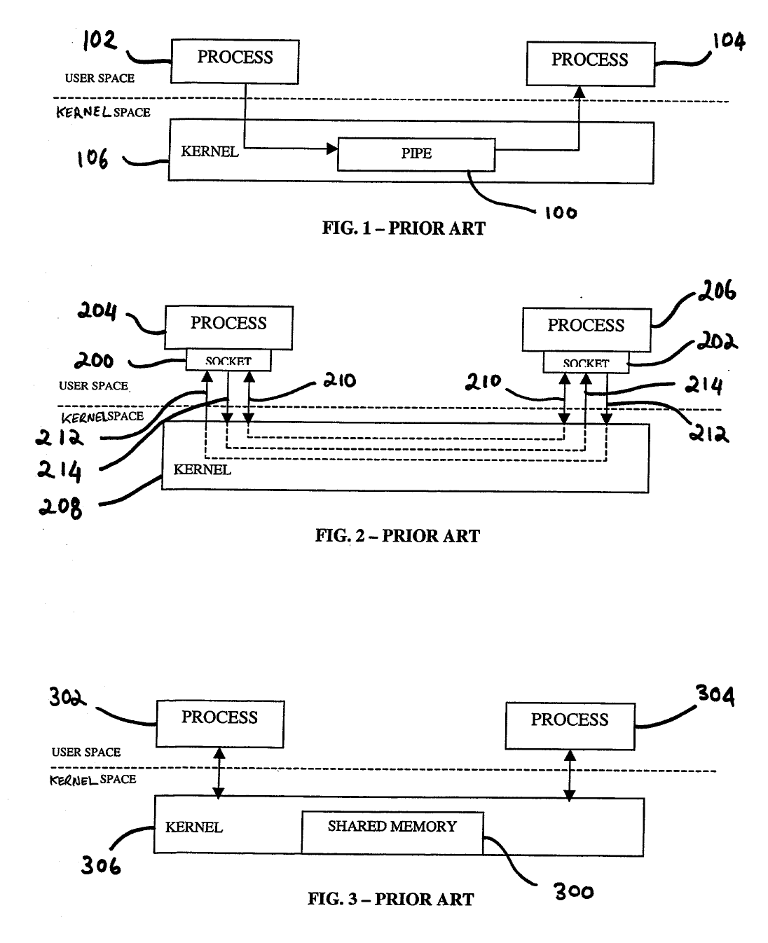

### DETAILED DESCRIPTION

Embodiments of the present invention are described herein in the context of fast socket technology implementation using memory maps and semaphores. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

Doors are a mechanism for communication between computer processes (IPC). In general, a door is a portion of memory in the kernel of an operating system that is used to facilitate a secure transfer of control and data between a client thread of a first computer process and a server thread of a second computer process.

The present invention uses a Speed Library that enables a combination of doors IPC and mapped memory files. In particular, the interposition technique is used to dynamically overlay INET-TCP sockets. The Speed Library design is based on the principle that minimizing system time translates directly to a gain in application performance.

The present invention relies on the concept of interposition of shared objects. For example, dynamic libraries allow a symbol to be interposed so that if more than one symbol exist, the first symbol takes precedence over all other symbols. The environment variable LD_PRELOAD can be used to load shared objects before any other dependencies are loaded. The Speed Library uses this concept to interpose functions that will be discussed in more details below.

Speed Library interposition is needed on both the server and the client applications. This interposition allows existing client-server applications to transparently use the library. For example, on the server side, LD_PRELOAD may be used to load the shared library LIBSPEEDUP_SERVER.SO. On the client side, LD_PRELOAD may be used to load LIBSPEEDUP_CLIENT.SO.

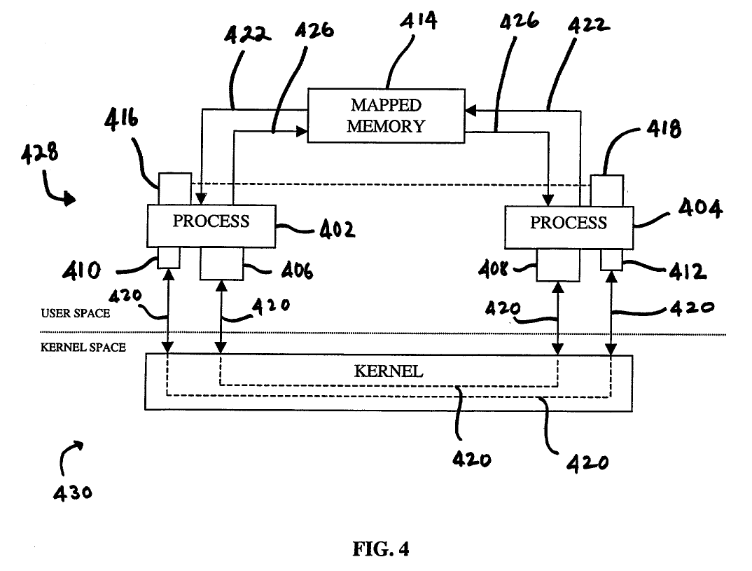

FIG. 4 is a block diagram illustrating an interprocess communication using a Speed Library according to a specific embodiment of the present invention. A process 402 communicates with another process 404 through doors 406, 408, semaphore 410, 412, and mapped memory 414. Each process 402, 404 opens a TCP socket 416, 418 respectively, which is associated with a socket library (not shown). Through interposition, process calls for the socket library are intercepted and redirected to the Speed Library (not shown) that is associated with a door IPC mechanism and a semaphore. The doors 406 and 408 are not used for context switching but set up the initial connection between process 402 and 404. The Speed Library enables process 402 to communicate data availability, or synchronization signals 420, with process 404 using system-scope semaphores 410, 412. Each process transfers data through the mapped memory 414.

For example, when process 402 opens socket 416 to read data from process 404 via socket 418, the read calls 422 are interposed with the Speed Library. Speed Library enables processes 402 and 404 to communicate synchronization signals using semaphores 410, 412 through kernel 424. The mapped memory 414 enables data to transfer from process 404 to process 402 based on the synchronization signals without sending the data through the kernel 424. When process 402 opens socket 416 to write data through socket 418 to process 404, the write calls 426 are interposed with the Speed Library. The Speed Library enables processes 402 and 404 to communicate synchronization signals using semaphores 410, 412 through kernel 424. The mapped memory 414 enables data to transfer from process 404 to process 402 based on the synchronization signals without sending the data through kernel 424. Both processes 402 and 404 are represented in the user space 428 while the kernel 424 is represented in the kernel space 430. Thus, the sockets 402 and 404 virtually communicate (represented by line 432) while the data and synchronization signals are actually transferred through the mapped memory 414 and semaphores 410, 412 respectively enabled by the Speed Library.

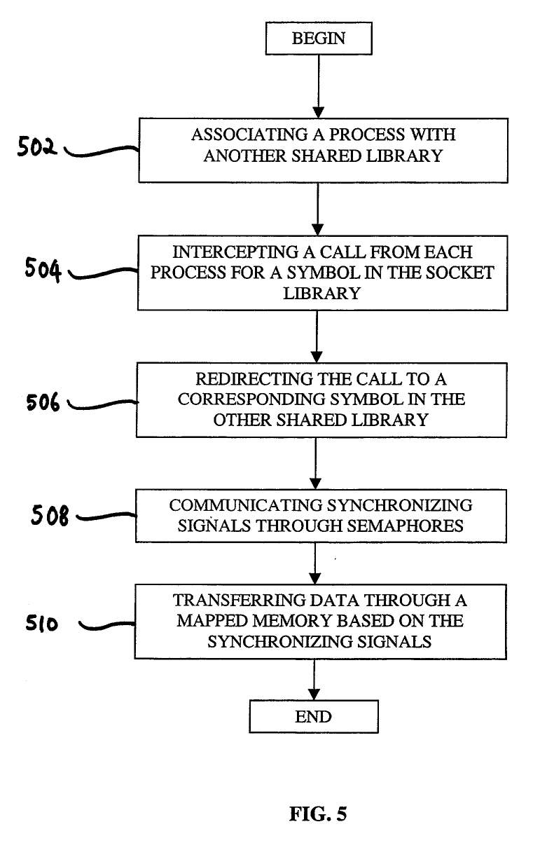

FIG. 5 is a flow diagram illustrating a method for moving data between a first process and a second process according to a specific embodiment of the present invention. In a first block 502, a second shared library, such as a Speed Library, is associated with a process through interposition. In block 504, a process call for a symbol in a first library, for example a TCP socket library, is intercepted by the interposer. The interposer in turn redirects the call for a corresponding symbol in the second shared library in step 506. The corresponding symbol enables a door for each process to set up an initial connection. The processes then communicate synchronizing signals through semaphores in block 508 and transfer data through a mapped memory in block 510 based on the synchronizing signals in block 508.

Data is copied into a memory map buffer to avoid making multiple copies of the data. In particular, a sliding window type of buffer management has been adopted. For every connection, the server creates a shared memory mapped segment. This segment is divided into multiple windows. Each window is further divided into slots. The number and sizes of slots are configurable.

The LIBSOCKET.SO ACCEPT is no longer called for loopback connections, but it is simulated. However, LIBSOCKET.SO ACCEPT is called for connections coming across the network. The connections are automatically pooled. This was done to re-use the memory map segments instead of creating them for every connection. The server caches the connection and, if a client re-connects, a connection is returned from the pool.

Data is now directly copied using BCOPY into an available slot in the mapped memory segment. Semaphores are only used to make a fast context switch into the server process. Data consumption is still based on the producer/consumer model. The producer now has more slots to copy the data, as the mapped memory segment is divided into windows and slots.

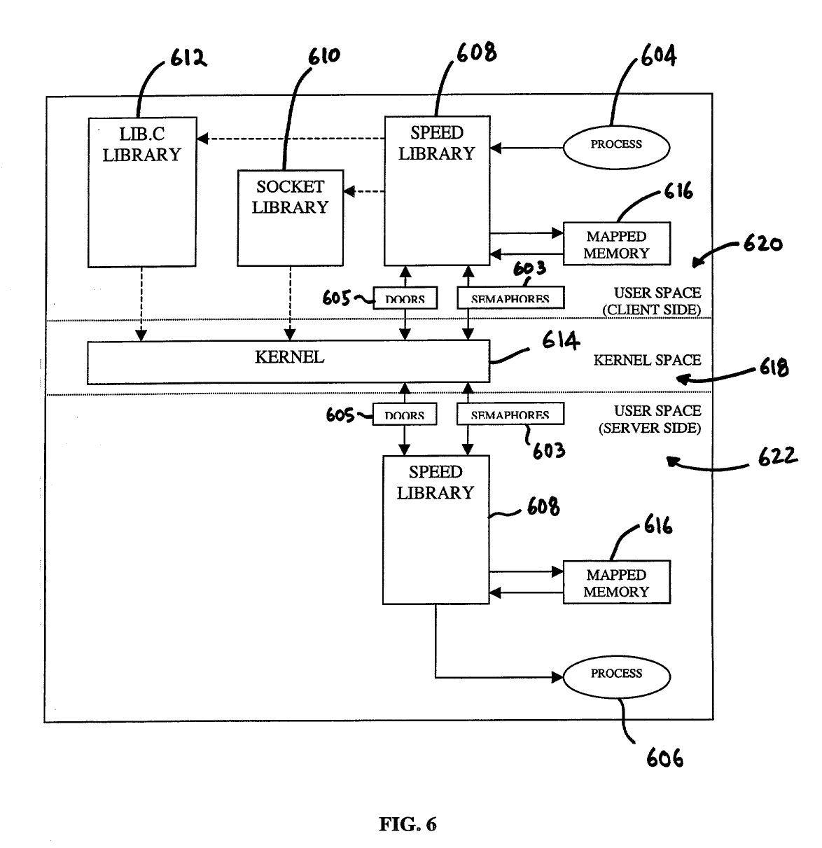

FIG. 6 illustrates a memory for moving data between processes according to a specific embodiment of the present invention. Memory 602 comprises several processes, for example processes 604 and 606, Speed Library 608, socket library 610, lib.c library 612, kernel 614, and mapped memory 616. Calls from process 604 for symbols in socket library 610 or the lib.c library 612 are intercepted by the speed library 608. The speed library 608 interposes the calls from process 604 redirects the calls for symbols to corresponding symbols in speed library 608. The speed library 608 comprises a list of symbols enabling process 604 to communicate with process 606 using doors 605 and semaphores 603. Doors 605 set up the initial connection between process 604 and 606, then synchronization signals are transmitted through the semaphores 603 through kernel 614 belonging to the kernel space 618. Process 604 transfers data with process 606 through the mapped memory 616.

In the user space on the client side 620, the speed library 608 however redirects the calls from process 604 either to the socket library 610 or the lib.c library 612 depending on whether the speed library 608 can handle these calls. For example, the speed library 608 redirects calls to the socket library 610 for file descriptors that are associated with remote sockets (to and from other hosts). The speed library 608 also redirects calls to the lib.c library 612 for any file descriptor not associated with a socket. The redirected calls to either the lib.c library 612 and the socket library 610 enable process 604 to communicate with process 606 through the kernel 614 in the kernel space 618. Data and synchronization signals are transmitted through their respective library to the process 606 back in the user space on the server side 622. For example, when process 604 calls for a remote socket in socket library 610, the data communicates through the socket library 610, the kernel 614, and back the socket library 610, and finally to process 606.

Because threads in two different processes need to be synchronized to send and receive data, a producer/consumer paradigm is used to transfer data. In transferring data from the client to the server, a write operation by the client is a read operation in the server. In other words, the client becomes the producer and the server becomes the consumer. The roles are reversed when transferring data from the server to the client, in which case the server becomes the producer and the client becomes the consumer.

System-scope semaphores are created in the shared memory mapped space, and a SEMA_POST is executed on these semaphores to signal data availability. The BIND, ACCEPT and CONNECT functions have similar functionality.

The server READ thread waits on a system-scope W_MGMT_PTR [SEMA_R_{—}0] semaphore. The client writes data directly into the memory mapped slot, and executes a SEMA_POST on W_MGMT_PTR [SEMA_R_{—}0] semaphore to wake up the server READ thread. The READ thread then executes a BCOPY to transfer the data from the memory mapped slot into the server read buffer.

The following illustrates an example of a code for a server side READ fiction of the Speed Library:

ssize_t read(int fd, void *buf, size_t nbyte)
{
...

if(fd > 0 && pmap[fd].fd == fd) {

| 1 | w_mgmt_ptr = pmap[fd].r_w_mgmt_ptr; |
|---|---|
| | if (pmap[fd].partial_read_flag = 0) { |

sema_ptr = (sema_t*)&w_mgmt_ptr[SEMA_R_O];

while(sema_wait(sema_ptr));

| | } |
|---|---|
| 2 | win = w_mgmt_ptr[SERVER_ACTIVE_WIN]; |
| | w_attr_ptr = (int*)(pmap[fd].r_w_attr_ptr_offset + |
| | WINDOW_INDEX(win)); |
| | mptr = pmap[fd].r_mptr; |
| | w_dptr = mptr + w_attr_ptr[DBUF_OFFSET]; |
| | w_dptr = w_dptr + w_attr_ptr[START_ADDR]; |
| | if(nbyte <= w_attr_ptr[CSZ]) { |

bcopy(w_dptr, buf, nbyte);
w_attr_ptr[START_ADDR] = nbyte;
w_attr_ptr[CSZ] = w_attr_ptr[CSZ] − nbyte;

} else if (nbyte > w_attr_ptr[CSZ]) {

bcopy(w_dptr, buf, w_attr_ptr[CSZ]);
nbyte = w_attr_ptr[CSZ];
w_attr_ptr[CSZ] = 0;

| | } |
|---|---|
| 3 | if (w_attr_ptr[CSZ] == 0) { |

w_attr_ptr[START_ADDR] = 0;
w_mgmt_ptr[SERVER_ACTIVE_WIN]++;
w_mgmt_ptr[SERVER_ACTIVE_WIN] =
w_mgmt_ptr[SERVER_ACTIVE_WIN]

% tparams.nowins;

rd_empty++;
pmap[fd].partial_read_flag = 0;
sema_ptr = (sema_t*)&w_mgmt_ptr[SEMA_R_E];
sema_post(sema_ptr);

}else {

pmap[fd].partial_read_flag = 1;

}
return nbyte;

}
return ((*fptr)(fd, buf, nbyte));

}

The server side WRITE thread waits on a system-scope W_MGMT_PTR [SEMA_W_E] semaphore. If successful, data is copied using BCOPY into the memory mapped slot. A SEMA_POST is then executed on the W_MGMT_PTR [SEMA_W_{—}0] semaphore to wake up the client READ thread.

The following illustrates an example of a code for a server side WRITE fiction of the Speed Library:

ssize_t write(int fd, const void *buf size_t nbyte)
{
...

if(fd > 0 && pmap[fd].fd == fd) {

| | cbuf = (void*)buf; |
|---|---|
| | csz = nbyte; |
| | w_mgmt_ptr = pmap[fd].w_w_mgmt_ptr; |
| 1 | mptr = pmap[fd].w_mptr; |
| | while(csz > 0) { |

| | sema_ptr = (sema_t*)&w_mgmt_ptr[SEMA_W_E]; |
|---|---|
| | while(sema_wait(sema_ptr)); |
| 2 | win = w_mgmt_ptr[CLIENT_ACTIVE_WIN]; |
| | w_attr_ptr = (int*)(pmap[fd].w_w_attr_ptr_offset + |
| | WINDOW_INDEX(win)); |
| | w_dptr = mptr + w_attr_ptr[DBUF_OFFSET]; |
| | if (csz <= w_attr_ptr[SZ]) { |

bcopy(cbuf, w_dptr, csz);
w_attr_ptr[CSZ] = csz;
cbuf = ((char*)cbuf) + csz;
csz = 0;

} else if (csz > w_attr_ptr[SZ]) {

bcopy(cbuf, w_dptr, w_attr_ptr[SZ]);
w_attr_ptr[CSZ] = w_attr_ptr[SZ];
csz = csz − w_attr_ptr[SZ];
cbuf = ((char*)cbuf) + w_attr_ptr[SZ];

}
w_mgmt_ptr[CLIENT_ACTIVE_WIN]++;
w_mgmt_ptr[CLIENT_ACTIVE_WIN] =
w_mgmt_ptr[CLIENT_ACTIVE_WIN]

% tparams.nowins;

| | |
|---|---|
| 3 | sema_ptr = (sema_t*)&w_mgmt_ptr[SEMA_W_O]; |
| | sema_post(sema_ptr); |

}

...
}

The client side READ thread waits on a system-scope semaphore. The server WRITE thread executes into a memory mapped slot and post on the semaphore. Data from the memory mapped slot is copied using BCOPY to the client READ buffer.

The client side WRITE thread waits on a system-scope semaphore for an empty memory mapped slot. Data is copied into the mapped memory slot. The SEMA_POST is executed on the semaphore to wake up the server READ thread.

The number and size of slots are configurable through environment variables. The number and size of slots could be increased for better performance. The environment variable SPEED_NOWINS may have a value range of 2 to 152. The environment variable SPEED_WINSIZE may have a value range of 256 to 8192.

Since the design is an interpose of the TCP socket library, client-server applications written in a variety of languages such as C, C++, or Java™, should be able to use it seamlessly

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for moving data between processes in a computer-based system, each process calling for one or more symbols in a first library, the method comprising:
associating each process with a second library, said second library comprising one or more symbols with a door interprocess communication mechanism, said door interprocess mechanism enabling each process to set up an initial connection, said connection subsequently communicating a synchronization signal using a semaphore, said one or more symbols enabling data communication through a mapped memory based on said synchronization signal;
intercepting a call from each process for a symbol in said first library; and
redirecting said call to a corresponding symbol in said second library.

2. A method according to claim 1 wherein said first library comprises one or more symbols associated with a socket interprocess communication mechanism.

3. A method according to claim 1 wherein said associating further comprises dynamically linking each process with said second library.

4. A method according to claim 1 wherein said second library comprises one or more server-side symbols and one or more client-side symbols.

5. A method according to claim 4 wherein said server-side symbols further comprise a bind symbol, an accept symbol, a read symbol, and a write symbol.

6. A method according to claim 4 wherein said client-side symbols further comprise a connect symbol, a read symbol, and a write symbol.

7. A program storage device readable by a machine, tangibly embodying a program of instructions readable by the machine to perform a method for moving data between processes in a computer-based system, each process calling for one or more symbols in a first library, the method comprising:
associating each process with a second library, said second library comprising one or more symbols with a door interprocess communication mechanism, said door interprocess mechanism enabling each process to set up an initial connection, said connection subsequently communicating a synchronization signal using a semaphore, said one or more symbols enabling data communication through a mapped memory based on said synchronization signal;
intercepting a call from each process for a symbol in said first library; and
redirecting said call to a corresponding symbol in said second library.

8. The program storage device according to claim 7 wherein said first library comprises one or more symbols associated with a socket interprocess communication mechanism.

9. The program storage device according to claim 7 wherein said associating further comprises dynamically linking each process with said second library.

10. The program storage device according to claim 7 wherein said second library comprises one or more server-side symbols and one or more client-side symbols.

11. The program storage device according to claim 10 wherein said server-side symbols further comprise a bind symbol, an accept symbol, a read symbol, and a write symbol.

12. The program storage device according to claim 10 wherein said client-side symbols further comprise a connect symbol, a read symbol, and a write symbol.

13. An apparatus for moving data between process in a computer-based system, the apparatus comprising:
a plurality of processes;
a mapped memory;
a first library having one or more symbols, said plurality of processes calling for said one or more symbols in said first library of symbols;
a second library having one or more symbols, said one or more symbols associated with a semaphore and a door interprocess communication mechanism setting up an initial connection; and
an interposer intercepting a call from a process for said one or more symbols in said first library and redirecting a call for corresponding said one or more symbols in said second library.

14. The apparatus according to claim 13 wherein said first library comprises one or more symbols associated with a socket interprocess communication mechanism.

15. The apparatus according to claim 13 wherein each process is dynamically linked with said second library.

16. The apparatus according to claim 13 wherein each process communicates a synchronization signal using said semaphore.

17. The apparatus according to claim 16 wherein each process transfers data through said mapped memory based on said synchronization signal.

18. The apparatus according to claim 13 wherein said second library further comprises one or more server-side symbols and one or more client-side symbols.

19. The apparatus according to claim 18 wherein said server-side symbols further comprise a bind symbol, an accept symbol, a read symbol, and a write symbol.

20. The apparatus according to claim 18 wherein said client-side symbols further comprise a connect symbol, a read symbol, and a write symbol.

21. An apparatus for moving data between processes in a computer-based system, each process calling for one or more symbols in a first library, the apparatus comprising:
means for associating each process with a second library, said second library comprising one or more symbols with a door interprocess communication mechanism, said door interprocess mechanism enabling each process to set up an initial connection, said connection subsequently communicating a synchronization signal using a semaphore, said one or more symbols enabling data communication through a mapped memory based on said synchronization signal;
means for intercepting a call from each process for a symbol in said first library; and
means for redirecting said call to a corresponding symbol in said second library.
